(19) United States
(12) Patent Application Publication
(10) Pub. No.: US 2012/0065961 A1
(43) Pub. Date: Mar. 15, 2012

(54) SPEECH MODEL GENERATING APPARATUS, SPEECH SYNTHESIS APPARATUS, SPEECH MODEL GENERATING PROGRAM PRODUCT, SPEECH SYNTHESIS PROGRAM PRODUCT, SPEECH MODEL GENERATING METHOD, AND SPEECH SYNTHESIS METHOD

(75) Inventors: Javier Latorre, Tokyo (JP); Masami Akamine, Kanagawa (JP)

(73) Assignee: KABUSHIKI KAISHA TOSHIBA, Tokyo (JP)

(21) Appl. No.: 13/238,187

(22) Filed: Sep. 21, 2011

Related U.S. Application Data
(63) Continuation of application No. PCT/JP2009/067408, filed on Oct. 6, 2009.

(30) Foreign Application Priority Data
Mar. 30, 2009 (JP) 2009-083563

(51) Int. Cl. G06F 17/27

(52) U.S. Cl. 704/9

(57) ABSTRACT

According to one embodiment, a speech model generating apparatus includes a spectrum analyzer, a chunker, a parameterizer, a clustering unit, and a model training unit. The spectrum analyzer acquires a speech signal corresponding to text information and calculates a set of spectral coefficients. The chunker acquires boundary information indicating a beginning and an end of linguistic units and chunks the speech signal into linguistic units. The parameterizer calculates a set of spectral trajectory parameters for a trajectory of the spectral trajectory parameters of the linguistic unit on the basis of the spectral coefficients. The clustering unit clusters the spectral trajectory parameters calculated for each of the linguistic units into clusters on the basis of linguistic information. The model training unit obtains a trained spectral trajectory model indicating a characteristic of a cluster based on the spectral trajectory parameters belonging to the same cluster.

### CROSS-REFERENCE TO RELATED APPLICATIONS

This application is a continuation of PCT international application Ser. No. PCT/JP2009/067408 filed on Oct. 6, 2009 which designates the United States, and which claims the benefit of priority from Japanese Patent Application No. 2009-083563, filed on Mar. 30, 2009; the entire contents of which are incorporated herein by reference.

### FIELD

Embodiments described herein relate generally to a speech model generating apparatus that generates a speech model, a speech synthesis apparatus that performs speech synthesis using the speech model, a speech model generating program product, a speech synthesis program product, a speech model generating method, and a speech synthesis method.

### BACKGROUND

A speech synthesis apparatus that generates speech from text includes three main processing units, i.e., a text analyzer, a prosody generator, and a speech signal generator. The text analyzer performs a text analysis of input text (a sentence including Chinese characters, kana characters or any other type of alphabet) using, for example, a language dictionary and outputs linguistic information defining, for example, the reading of Chinese characters, the position of the accent, the boundaries of segment, e.g. accent phrases, etc. On the basis of the linguistic information, the prosody generator outputs prosodical information for each phoneme, such as the pattern (pitch envelope) of variation in the pitch of speech (basic frequency) over time and the length of each phoneme. Finally, on the basis of the phoneme sequence from the text analyzer and the prosody information from the prosody generator, the speech signal generator generates a speech waveform. Currently, the two main-stream approaches in Text to Speech (TTS) are concatenative synthesis and Hidden Markov Model-based (HMM-based) synthesis.

In concatenative synthesis, fragments of speech are selected according to the phonetic and prosodic information, and eventually the pitch and duration of the fragments are modified according to the prosody information. Finally, synthetic speech is created by concatenating these fragments. In this method, the fragments which are pasted to generate the speech waveform are real speech stored in a database. Therefore, this method's advantage is that natural synthetic speech can be obtained. However, this method requires a considerably large database to store the speech fragments.

An HMM-based synthesis generates synthetic speech using a synthesizer called a vocoder, which drives a synthesis filter with a pulse sequence or noise. The HMM-based synthesis is one of the speech synthesis methods based on a statistical modeling. In this method, instead of directly storing the parameters of the synthesizer in a database, they represented by statistical models automatically trained using the speech data. The parameters of the synthesizer are then generated from these statistical models by maximizing their log-likelihood for the input sentence. Since the number of statistical models is lower than that of speech fragments, HMM-based synthesis allows to obtain a speech synthesis system with reduce memory footprint.

The parameters of the synthesizer that are generated consist of the parameters of the synthesis filter, such as LSF or Mel-Cepstral coefficients that represent the spectrum of the speech signal, and the parameters of the driving signal. The time series of the parameters is modeled for each phoneme by an HMM with Gaussian distributions.

However, in the conventional speech synthesis method based on an HMM statistical model, the output spectrum is averaged by the statistical modeling. Therefore, the generated synthetic speech sounds muffled, i.e., unclear.

A method of solving the deterioration of the quality of sound due to the averaging or over-smoothing of the parameters consists of adding a model of the variance of the trajectory of the spectrum coefficients over the entire sentence, calculated from the training data. Then, at synthesis time the parameters are generated using that variance model as an additional constraint (Toda. T. and Tokuda K., 2005 “Speech Parameter Generation Algorithm Considering Global Variance for HMM-Based Speech Synthesis,” Proc. Interspeech 2005, Lisbon, Portugal, pp. 2801-2804).

The method disclosed in “Speech Parameter Generation Algorithm Considering Global Variance for HMM-Based Speech Synthesis” has the effect of recovering part of the dynamic of the spectrum of natural speech. However, its usage is only effective when the spectrum is parameterized by Mel-Cepstral parameters, and even then sometimes it produces unstable speech.

### BRIEF DESCRIPTION OF THE DRAWINGS

FIG. 1 is a block diagram illustrating the configuration of a speech model generating apparatus;

FIG. 2 is a diagram illustrating linguistic units;

FIG. 3 is a diagram illustrating an example of a decision tree;

FIG. 4 is a flowchart illustrating a speech model generating process;

FIG. 5 is a diagram illustrating spectrum parameters obtained by a parameterizer;

FIG. 6 is a diagram illustrating spectrum parameters obtained in a frame unit by an HMM;

FIG. 7 is a diagram illustrating the configuration of a speech synthesis apparatus;

FIG. 8 is a flowchart illustrating a speech synthesis process of the speech synthesis apparatus; and

FIG. 9 is a diagram illustrating the hardware configuration of the speech model generating apparatus.

### DETAILED DESCRIPTION

In general, according to one embodiment, a speech model generating apparatus includes a text analyzer, a spectrum analyzer, a chunker, a parameterizer, a clustering unit, and a model training unit. The text analyzer performs a text analysis of text information to generate linguistic context. The spectrum analyzer acquires a speech signal corresponding to the text information and calculates a set of spectral coefficients, e.g. mel-cepstral. The chunker acquires boundary information indicating a beginning and an end of linguistic units and chunks the speech signal into the linguistic units. The parameterizer calculates a set of parameters that described the trajectory of the spectral features over the linguistic unit, i.e. spectral trajectory parameters. The clustering unit clusters a plurality of spectral trajectory parameters calculated for each of the linguistic units into clusters on the basis of the linguistic context. The model training unit obtains a trained spectral trajectory model indicating for each cluster a statistical distribution of the spectral trajectory parameters belonging to that cluster.

Hereinafter, a speech model generating apparatus, a speech synthesis apparatus, a program, and a method according to exemplary embodiments will be described with reference to the accompanying drawings.

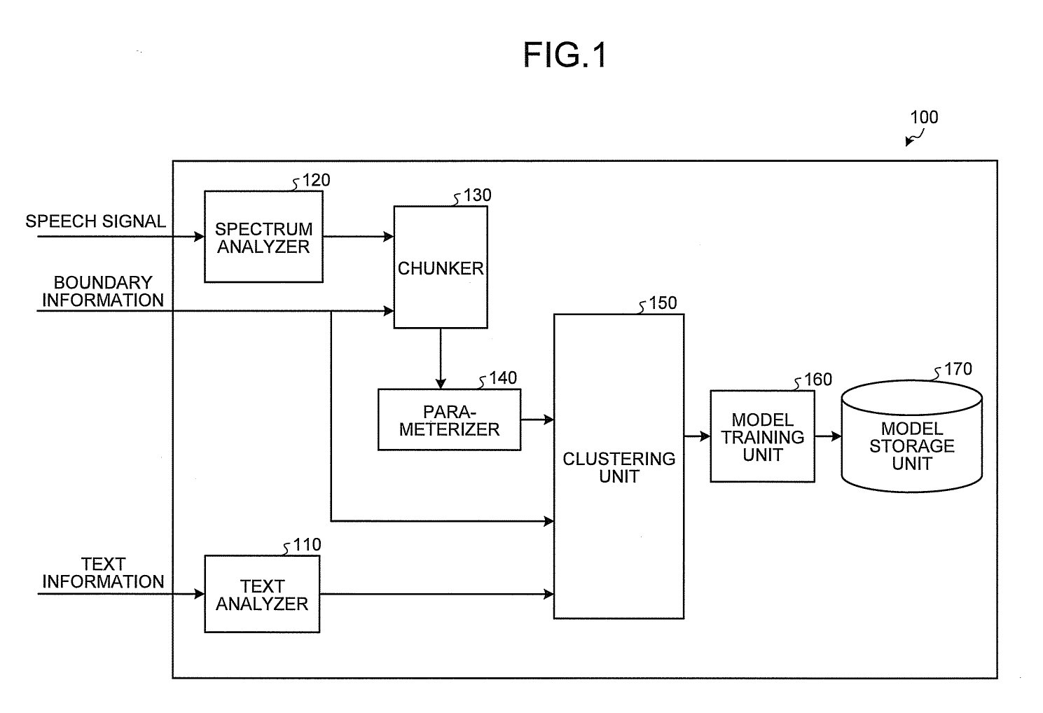

FIG. 1 is a block diagram illustrating the configuration of a speech model generating apparatus 100 according to an embodiment. The speech model generating apparatus 100 includes a text analyzer 110, a spectrum analyzer 120, a chunker 130, a parameterizer 140, a clustering unit 150, a model training unit 160, and a model storage unit 170. The speech model generating apparatus 100 acquires as training data text information and speech signal which is the utterance of the content of the text information. Then, on the basis of such training data it produces a speech model for speech synthesis.

The text analyzer 110 acquires text information. The text analyzer 110 performs a text analysis of the acquired text information to generate linguistic information for each linguistic unit. Examples of a linguistic unit are a phoneme, a syllable, a word, a phrase, a unit between breaths, and a whole utterance. The linguistic information includes information indicating the position of the boundary between linguistic units; information indicating whether the morpheme of each linguistic unit, the phonemic symbol of each linguistic unit, and each phoneme are voiced sounds or unvoiced sounds; information indicating whether there is an accent in each phoneme; information about the start time and end time of each linguistic unit; information about the linguistic units before and after a target linguistic unit; information indicating the linguistic relationship between adjacent linguistic units, etc. The set of all the linguistic information is called linguistic context. The clustering unit 150 uses the linguistic context to split the spectral trajectory parameters into different clusters.

The spectrum analyzer 120 acquires a speech signal. The speech signal is an audio signal with the utterance by a speaker of the content of the text information that is given as input to the text analyzer 110. The spectrum analyzer 120 performs a spectrum analysis of the acquired speech signal. That is, the spectrum analyzer 120 first divides the speech signal into frames of about 25 ms. Then, it calculates for each frame a set of coefficients that describe the shape of the spectrum of that frame, e.g. Mel frequency cepstrum coefficient (MFCC) and outputs these spectral coefficients to the chunker 130.

The chunker 130 acquires boundary information from an external source. The boundary information indicates the position of the beginning and end of the linguistic units contained on the speech signal. The boundary information can be generated by manual alignment or by automatic alignment. The automatic alignment can be obtained, for example, using a speech recognition model. The boundary information forms part of the training data for the system. The chunker 130 specifies the linguistic unit of the speech signal on the basis of the boundary information and for each linguistic unit, it chunks the corresponding vector of spectral coefficients, e.g., MFCCs, acquired from the spectrum analyzer 120.

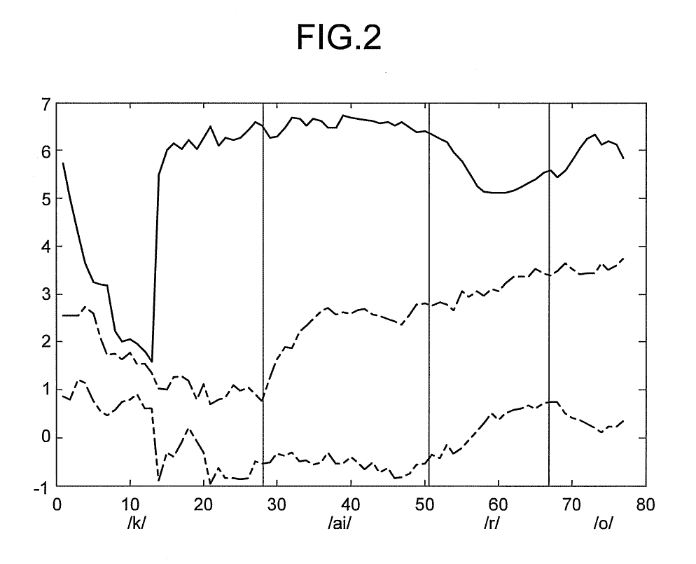

As shown in FIG. 2, for example, the MFCC curve corresponding to text information [kairo] is partitioned into the linguistic units of four phonemes /k/, /ai/, /r/, and /o/, each of which is a phoneme unit. Usually, each linguistic unit extends across multiple frames. The chunker 130 performs chunking of the MFCCs at a plurality of linguistic units, such as a phoneme, a syllable, a word, a phrase, a unit between breaths, and a whole utterance.

The subsequent process which will be described below is performed at each of the linguistic units. A case in which a phoneme is used as the linguistic unit will be described below as an example.

The parameterizer 140 acquires the vector of MFCCs coefficients of the linguistic unit chunked by the chunker 130 and calculates spectral trajectory parameters for each MFCC dimension. The complete spectral trajectory parameters consists of basic parameters and additional parameters.

When the number of frames included in the linguistic unit is k, the parameterizer 140 applies a Nth-order transformation, e.g., DCT, to the kth-dimensional vector MelCepi,s composed of the ith component of the MFCCs over all the frames associated with the linguisit unit s as shown in Equation 1:

X_{i,s}=T_{i,s}·MelCep_{i,s} (1)

This set of Xi,s parameters are the basic parameter of the linguistic unit. They describe the main characteristics of the spectrum of that unit.

In Equation 1 MelCepi,s is a kth-dimensional vector of an ith-order MFCCs of a phoneme s. Ti,s is a conversion matrix of Nth-order DCT corresponding to the number k of frames of the phoneme s. The dimension of the conversion matrix Ti,s depends on the number of frames associated with the linguistic unit. In calculating the basic parameters, various kinds of linear transform other than DCT may be used such as Fourier transform, wavelet transform, Taylor expansion, or multinomial expansion.

The parameterizer 140 also calculates some additional parameters. The additional parameter describe the relationship between the spectrum of the target unit and that of the adjacent units. One possible type of additional parameter is the gradient of the MFCC vector at the boundary between current linguistic unit and its adjacent units. The term “adjacent units” refers to the previous unit which is located immediately before the target unit and the next unit which is located immediately after the target unit. The additional parameter representing the gradient with the previous unit is represented by the following Expression:

ΔMelCep_{i,s}^{left}

The additional parameter representing the gradient with the next unit is represented by the following Expression:

ΔMelCep_{i,s}^{right}

The additional parameter representing the gradient with the previous unit and the additional parameter of the next unit are calculated by the following Equations 2 and 3:

$$\begin{matrix}Δ {MelCep}_{i , s}^{left} = {\sum }_{w = 0}^{W} α ( w ) \cdot {MelCep}_{i , s} ( w ) + {\sum }_{w = - W}^{- 1} α ( w ) {MelCep}_{i , s - 1} ( - w ) & ( 2 ) \\ Δ {MelCep}_{i , s}^{righ} = {\sum }_{w = - W}^{0} α ( w ) \cdot {MelCep}_{i , s} ( w ) + {\sum }_{w = 1}^{W} α ( w ) \cdot {MelCep}_{i , s + 1} ( w ) & ( 3 )\end{matrix}$$

(where α is a Wth-dimensional weight vector for calculating the gradient).

A negative index in the parentheses indicates an element counted from the last element of the vector.

The additional parameters can be rearranged as in the following Equations 4 and 5 using the basic spectral trajectory parameters Xi,s:

ΔMelCep_{i,s}^{left}=H_{i,s}^{begin}·X_{i,s}+H_{i,s-1}^{end}·X_{i,s-1} (4)

ΔMelCep_{i,s}^{right}=H_{i,s}^{end}·X_{i,s}+Hₛ₊₁^{begin}·X_{i,s-1} (5)

That is, the additional parameters can be represented as a function of the basic parameters Xi,s.

In addition,

H_{i,s}^{begin}

and

H_{i,s}^{end}

are represented by the following Equations 6 and 7, respectively:

$$\begin{matrix}{H}_{i , s}^{begin} = {\sum }_{w = 0}^{W} α ( w ) \cdot {T}_{i , s}^{- 1} ( w ) & ( 6 ) \\ {H}_{i , s}^{end} = {\sum }_{w = - W}^{0} α ( w ) \cdot {T}_{i , s}^{- 1} ( - w ) & ( 7 )\end{matrix}$$

The parameterizer 140 concatenates the basic parameters and the additional parameters into a single vector SPi,s to form the total trajectory parameterization, as shown in Equation 8:

SP_{i,s}=(X_{i,s}^{t},ΔMelCep_{i,s}^{left},ΔMelCep_{i,s}^{right})^{t} (8)

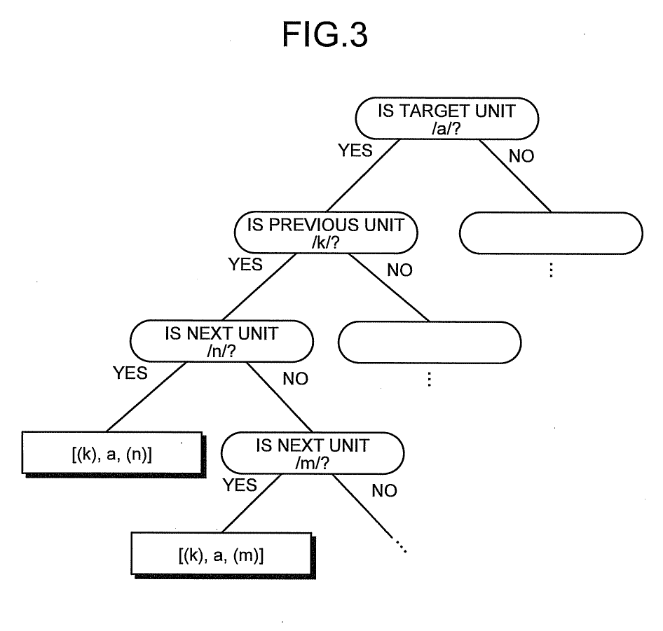

The clustering unit 150 clusters the spectral trajectory parameters of each linguistic unit obtained by the parameterizer 140 on the basis of the boundary information and the linguistic information generated by the text analyzer 110. Specifically, the clustering unit 150 clusters the spectral trajectory parameters into clusters on the basis of a decision tree in which branching is repeated while a question about linguistic context is repeated. For example, as shown in FIG. 3, the spectral trajectory parameters are split into a child node “Yes” and a child node “No” according to whether a response to a question “Is the target unit /a/?” is Yes or No. The spectral trajectory parameters are repeatedly split by the question and the response so that at the end spectral trajectory parameters having the similar linguistic context, are grouped in the same cluster, as shown in FIG. 3.

In the example shown in FIG. 3, clustering is performed such that the spectral trajectory parameters of target units having the same phonemes in the target unit, the previous unit, and the next unit are clustered together. In the example shown in FIG. 3, when the target unit is a phoneme /a/, [(k) a (n)] and [(k) a (m)] having different phonemes before or after the target unit are clustered into different clusters. The above-mentioned clustering is one example. Linguistic context other than the phonemes in each unit may be used to perform clustering. For example, linguistic context, such as information indicating whether there is an accent in the target unit or information indicating whether there is an accent in the previous unit and the next unit, may be used.

In this embodiment, clustering is performed on the spectral trajectory parameters obtained by the concatenation of the basic parameters and the additional parameters corresponding to all-dimensional coefficient vectors of the MFCC. In another example, clustering may be performed independently for the trajectory of each dimension of the spectral coefficients, i.e, MFCC, or for different sets of the spectral trajectory parameters. When clustering is performed for each dimension, the total dimension of the spectral trajectory parameters to be clustered is lower than in the case when the spectral trajectory parameters of all the dimensions are concatenated together. Therefore, it is possible to improve the accuracy of the clustering. Similarly, clustering may be performed after the dimension of the concatenated spectral trajectory parameters is reduced by, for example, PCA (Principal Component Analysis) algorithm.

The model training unit 160 learns the parameters of a parametric distribution, e.g. a Gaussian, that approximates the statistical distribution of the spectral trajectory parameters from all the units clustered into each cluster. In this way, the model training unit 160 outputs a context-dependent model of the spectral trajectory parameters. Specifically, if the parametric distribution is a mixture of Gaussians, the model training unit 160 outputs for each cluster the weight, average vector mi,s, and covariance matrix Σi,s of each Gaussian mixture in the cluster. The model training unit 160 also outputs the decision tree that maps the linguistic context of a target unit with its cluster. Any method that is well known in the field of speech recognition may be used for clustering or for training the parameters of the Gaussian distributions.

The model storage unit 170 stores the models output from the model training unit 160 so as the models are associated with the conditions of linguistic information common to the models. The conditions of the linguistic information mean linguistic context used for the questions in the clustering.

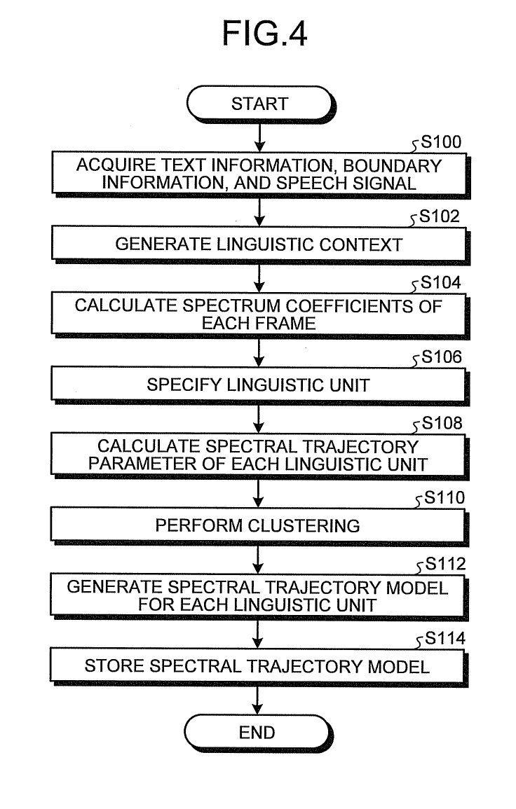

FIG. 4 is a flowchart illustrating a speech model generating process of the speech model generating apparatus 100. In the speech model generating process, first, the speech model generating apparatus 100 acquires, as training data, text information, the speech signal corresponding to the text and boundary information indicating the beginning and end of the linguistic units in the speech signal (Step S100). Specifically, the text information is input to the text analyzer 110, the speech signal is input to the spectrum analyzer 120, and the boundary information is input to the chunker 130 and the clustering unit 150.

Then, the text analyzer 110 generates linguistic context on the basis of the text information (Step S102). The spectrum analyzer 120 calculates the spectral coefficients, e.g., MFCC, of each frame of the speech signal (Step S104). The generation of the linguistic context by the text analyzer 110 and the calculation of the spectral coefficients by the spectrum analyzer 120 are independently performed. Therefore, the order in which these processes are performed is not particularly limited.

Then, the chunker 130 cuts out the linguistic unit of the speech signal on the basis of the boundary information (Step S106). Then, the parameterizer 140 calculates the spectral trajectory parameters of the linguistic unit from the MFCC of each of the frames in the linguistic unit (Step S108). Specifically, the parameterizer 140 calculates the spectral trajectory parameters SPi,s, which have the basic parameters and the additional parameters as elements, on the basis of the MFCCs of the frames in the units located immediately before and after the target unit, in addition to those in the target unit.

Then, on the basis of the boundary information and the linguistic information, the clustering unit 150 clusters the spectral trajectory parameters, which are obtained from each linguistic unit of the text information by the parameterizer 140 (Step S110). Then, the model training unit 160 generates a spectral trajectory model from the spectral trajectory parameters belonging to each cluster (Step S112). Then, the model training unit 160 stores the spectral trajectory model in the model storage unit 170, together with the decision tree that maps the spectral trajectory models with their corresponding text information and linguistic context obtained during the clustering process (the conditions of the linguistic information) (Step S114). Then, the speech model generating process of the speech model generating apparatus 100 ends.

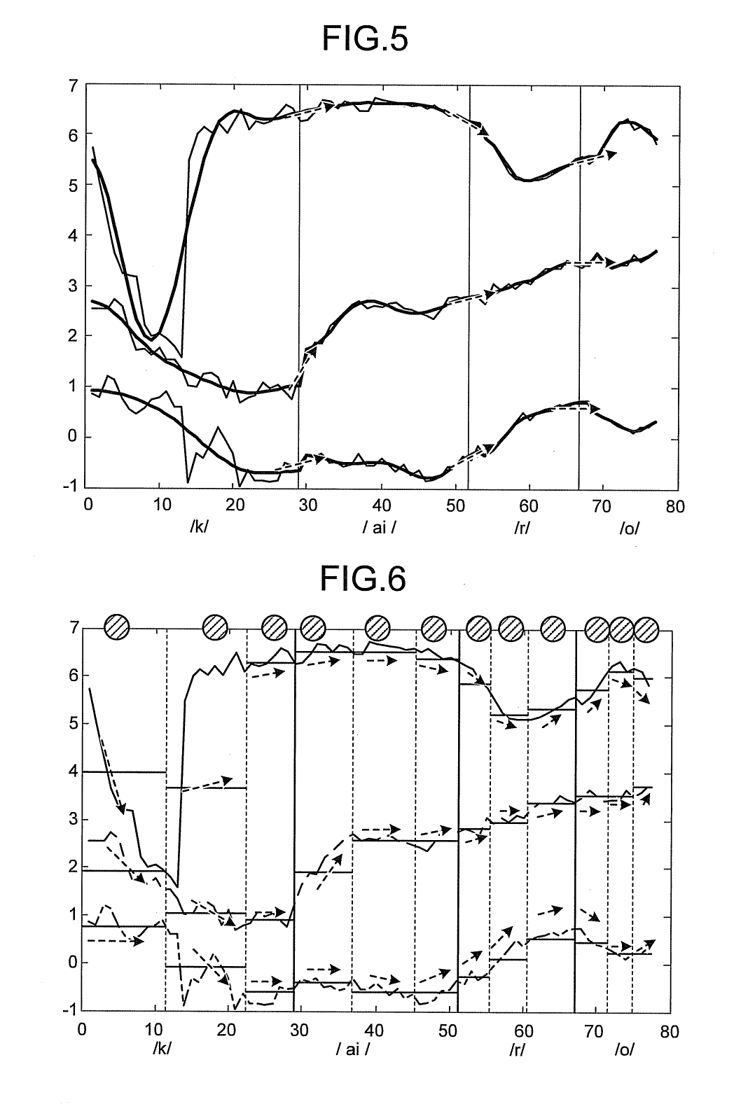

As can be seen from FIGS. 5 and 6, the speech model generating apparatus 100 according to this embodiment might be able to generate spectrum coefficients closer to the actual ones, as compared to spectrum coefficients obtained from a standard HMM. The speech model generating apparatus 100 computes the spectral trajectory models from the spectrum coefficients of a linguistic unit corresponding to a plurality of frames. Therefore, it is possible to obtain a more accurate model of spectral coefficients and consequently it is possible to generate more natural speech.

The speech model generating apparatus 100 considers the additional parameters of the units immediately before and after the target unit as well as the basic parameters of the target unit. Therefore, the speech model generating apparatus 100 can obtain a spectral trajectory model that varies smoothly without generating discontinuities.

The speech model generating apparatus 100 obtains the trained trajectory models from a plurality of linguistic units. Therefore, the speech model generating apparatus 100 can generate an integrated spectrum pattern using the spectral trajectory models or multiple linguistic units simultaneously.

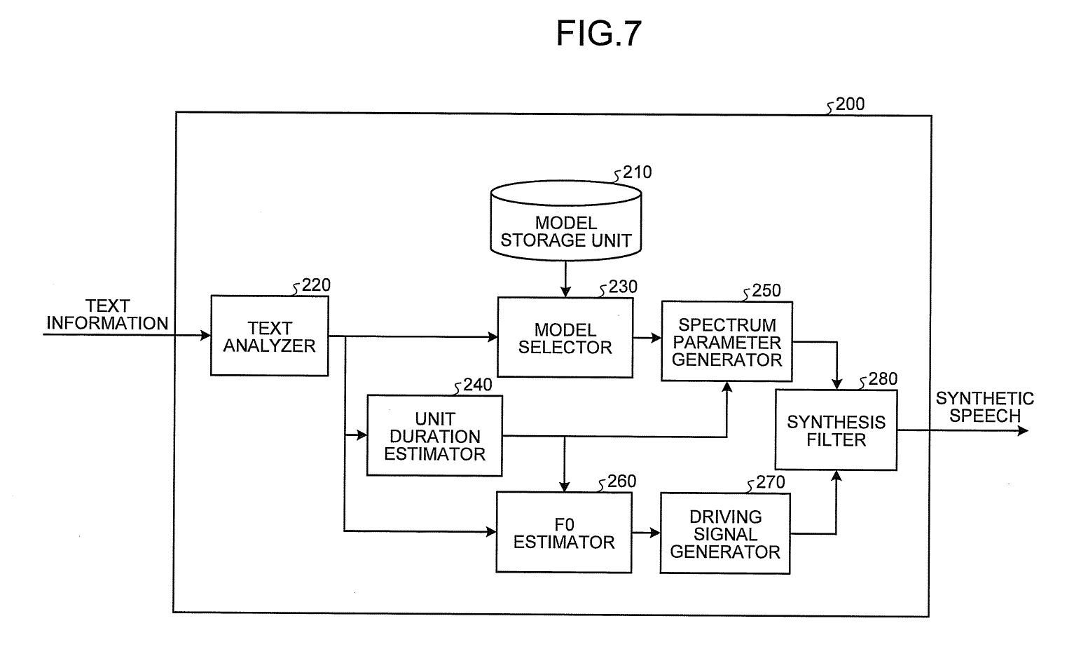

FIG. 7 is a diagram illustrating the configuration of a speech synthesis apparatus 200. The speech synthesis apparatus 200 acquires the text information which speech has to be synthesized, and performs speech synthesis on the basis of the spectrum model generated by the speech model generating apparatus 100. The speech synthesis apparatus 200 includes a model storage unit 210, a text analyzer 220, a model selector 230, a unit duration estimator 240, a spectrum parameter generator 250, an F0 estimator 260, a driving signal generator 270, and a synthesis filter 280.

The model storage unit 210 stores the models generated by the speech model generating apparatus 100 together with the decision tree that maps them to a specific linguistic context. The model storage unit 210 may be similar to the model storage unit 170 in the speech model generating apparatus 100. The text analyzer 220 acquires from an external source, e.g., a board, the text information, which speech is to be synthesized, Then, the text analyzer 220 performs the same process as that performed by the text analyzer 110 on the text information. That is, the text analyzer 220 generates linguistic context corresponding to the acquired text information. The model selector 230 selects from the model storage unit 210 context-dependent spectral trajectory models for each one of the linguistic units in the text information, which is input to the text analyzer 220, on the basis of the linguistic context of each unit. The model selector 230 connects the individual spectral trajectory models, which are selected for the linguistic units in the text information, and outputs them as a sequence of models corresponding to the entire input text.

The unit duration estimator 240 acquires linguistic context from the text analyzer 220 and estimates the more suitable duration of each linguistic unit according to such linguistic contexts.

The spectrum parameter generator 250 receives the model sequence of the linguistic units selected by the model selector 230 and a duration sequence obtained by connecting the individual durations calculated for each linguistic unit by the unit duration estimator 240, and calculates spectrum coefficients corresponding to the entire input text. Specifically, the spectrum parameter generator 250 calculates the trajectories of spectrum coefficients that maximize a total objective function. The total objective function F is the log likelihood (likelihood function) of the spectral trajectory parameters SPi,s based on the model sequence and the duration sequence. The total objective function F is represented by the following Equation 9:

$$F = {\sum }_{∀ s} log ( P ( {SP}_{i , s} \vert s ) ) \qquad ( 9 )$$

(where s is a set of units).

When the spectral trajectory parameters are modeled by single Gaussian distributions, the probability of the trajectory parameters is given as the probability density of the Gaussian distribution, as shown in the following Equation 10:

P(SP_{i,s}|s)=N(SP_{i,s};μ_{i,s},Σ_{i,s}) (10)

In order to calculate the spectrum coefficients, the total objective function F is maximized with respect to the basic spectral trajectory parameter Xi,s of the most basic linguistic unit (phoneme). In this embodiment, it is assumed that the objective function is maximized by a known technique, such as a gradient method. The maximization of the objective function makes it possible to calculate the most suitable spectral trajectory parameters.

The spectrum parameter generator 250 may maximize the objective function by taking into consideration the global variance of the spectrum. With this way of maximization, the variance of the generated spectrum pattern is more similar to the variance of the spectrum pattern of natural speech. Thus, it is possible to obtain more natural speech.

Finally, the spectrum parameter generator 250 generates the spectrum coefficients MFCCs of the frames in the phoneme by computing the inverse transformation of the basic spectrum trajectory parameters Xi,s obtained in the maximization of the objective function. The inverse transformation is performed for the frames included in the linguistic unit.

The F0 estimator 260 acquires the linguistic information from the text analyzer 220 and the duration of each linguistic unit from the unit duration estimator 240. The F0 estimator 260 estimates the basic frequency (F0) on the basis of the linguistic context provided by the text analyzer 220, and the duration of each linguistic unit.

The driving signal generator 270 acquires the basic frequency (F0) from the F0 estimator 260 and generates a driving signal from the basic frequency (F0). Specifically, in the most basic vocoder implementation, when the target unit is a voiced sound, the driving signal generator 270 generates as driving signal a sequence of pulses separated by the pitch period, i.e., the inverse of the basic frequency (F0). When the target unit is an unvoiced sound, the driving signal generator 270 generates white noise for the duration of the target unit.

The synthesis filter 280 generates synthetic speech from the spectrum coefficients produced by the spectrum parameter generator 250 and the driving signal generated by the driving signal generator 270 and outputs the synthetic speech. Specifically, the spectrum coefficients are first converted into a synthesis filter coefficients, represented by the following Equation 11:

$$H ( Z ) = \frac{{\sum }_{i = 0}^{q} {β}_{i} {Z}^{- i}}{{\sum }_{i = 1}^{p} {α}_{i} {Z}^{- i}} \qquad ( 11 )$$

(where p and q are the order of the synthesis filter coefficients).

When a driving signal e(n) input to synthesis filter an output signal y(n) is generated. The operation of the synthesis filter is represented by the following Equation 12:

$$y ( n ) = {\sum }_{i = 0}^{q} {β}_{i} e ( n - 1 ) + {\sum }_{i = 1}^{p} {α}_{i} y ( n - i ) \qquad ( 12 )$$

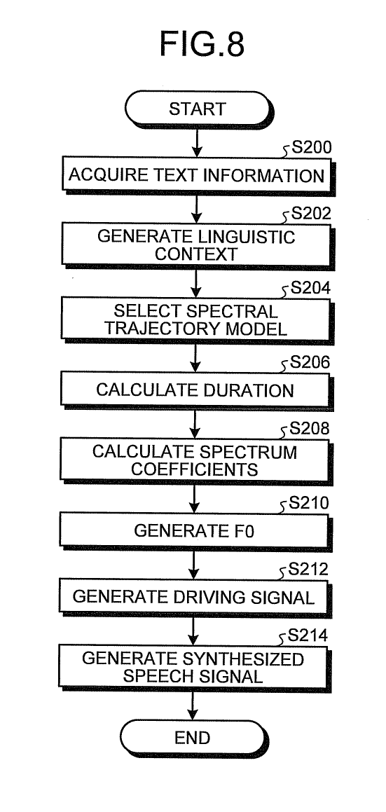

FIG. 8 is a flowchart illustrating a speech synthesis process of the speech synthesis apparatus 200. In the speech synthesis process, first, the text analyzer 220 acquires text information, which is a speech synthesis target (Step S200). Then, the text analyzer 220 generates linguistic context on the basis of the acquired text information (Step S202). Then, the model selector 230 selects from the model storage unit 210 the spectral trajectory models for the linguistic units included in the text information on the basis of the linguistic context generated by the text analyzer 220 and connects the individual spectral trajectory models to obtain a model sequence (Step S204). Then, the unit duration estimator 240 estimates the duration of each linguistic unit on the basis of the linguistic context (Step S206).

Then, the spectrum parameter generator 250 calculates spectrum coefficients corresponding to the text information on the basis of the model sequence and the duration sequence (Step S208). Then, the F0 estimator 260 generates the basic frequency (F0) of the pitch on the basis of the linguistic information and the duration (Step S210). Then, the driving signal generator 270 generates a driving signal (Step S212). Then, the synthesis filter 280 generates a synthetic speech signal and outputs the synthetic speech signal (Step S214). Then, the speech synthesis process ends.

The speech synthesis apparatus 200 according to this embodiment performs speech synthesis using a spectral trajectory model which is represented by DCT coefficients and is generated by the speech model generating apparatus 100. Therefore, it is possible to generate a natural spectrum that varies smoothly.

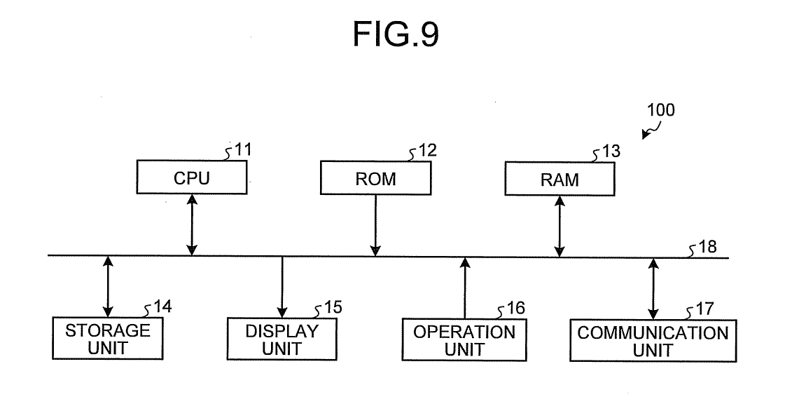

FIG. 9 is a diagram illustrating the hardware configuration of the speech model generating apparatus 100. The speech model generating apparatus 100 includes a CPU (Central Processing Unit) 11, a ROM (Read Only Memory) 12, a RAM (Random Access Memory) 13, a storage unit 14, a display unit 15, an operation unit 16, and a communication unit 17, which are connected to each other by a bus 18.

The CPU 11 uses the RAM 13 as a work area, performs various kinds of processes in cooperation with programs stored in the ROM 12 or the storage unit 14, and controls the overall operation of the speech model generating apparatus 100. In addition, the CPU 11 implements the above-mentioned functional components in cooperation with the programs stored in the ROM 12 or the storage unit 14.

The ROM 12 stores programs or various kinds of setting information required to control the speech model generating apparatus 100 such that the programs or the information cannot be rewritten. The RAM 13 is a volatile memory, such as an SDRAM or a DDR memory, and functions as a work area of the CPU 11.

The storage unit 14 has a storage medium that can magnetically or optically record information and rewritably store programs or various kinds of information required to control the speech model generating apparatus 100. In addition, the storage unit 14 stores, for example, the spectrum models generated by the model training unit 160. The display unit 15 is a display device, such as an LCD (Liquid Crystal Display), and displays, for example, characters or images under the control of the CPU 11. The operation unit 16 is an input device, such as a mouse or a keyboard, receives information input by the user as an instruction signal, and outputs the instruction signal to the CPU 11. The communication unit 17 is an interface that communicates with an external apparatus and outputs various kinds of information received from the external apparatus to the CPU 11. In addition, the communication unit 17 transmits various kinds of information to the external apparatus under the control of the CPU 11. The hardware configuration of the speech synthesis apparatus 200 is the same as that of the speech model generating apparatus 100.

A speech model generating program and a speech synthesis program executed by the speech model generating apparatus 100 and the speech synthesis apparatus 200 according to this embodiment may be provided by being incorporated into, for example, a ROM.

The speech model generating program and the speech synthesis program executed by the speech model generating apparatus 100 and the speech synthesis apparatus 200 according to this embodiment may be stored as files in an installable format or an executable format and may be provided by being stored in a computer-readable storage medium, such as a CD-ROM, a flexible disk (FD), a CD-R, or a DVD (Digital Versatile Disk).

The speech model generating program and the speech synthesis program executed by the speech model generating apparatus 100 and the speech synthesis apparatus 200 according to this embodiment may be provided by being stored in a computer that is connected to a network, such as the Internet, or may be provided by being downloaded through the network. In addition, the speech model generating program and the speech synthesis program executed by the speech model generating apparatus 100 and the speech synthesis apparatus 200 according to this embodiment may be provided or distributed through a network, such as the Internet.

The speech model generating program and the speech synthesis program executed by the speech model generating apparatus 100 and the speech synthesis apparatus 200 according to this embodiment have a modular configuration including the above-mentioned components. A CPU (processor) reads the speech model generating program and the speech synthesis program from the ROM and executes the programs. Then, the above-mentioned components are loaded to a main storage device and are then generated on the main storage device.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech model generating apparatus comprising:
a text analyzer that acquires text information and performs a text analysis of the text information to generate linguistic context of the text information;
a spectrum analyzer that acquires a speech signal corresponding to the text information and calculates a set of spectral coefficients that describe a spectrum shape of each frame of the speech signal;
a chunker that acquires boundary information indicating a beginning and an end of linguistic units and chunks the speech signal into the linguistic units on the basis of the boundary information, each linguistic unit expanding over multiple frames of the speech signal;
a parameterizer that calculates a set of spectral trajectory parameters for a trajectory of the spectral coefficients associated with the linguistic unit;
a clustering unit that clusters a plurality of spectral trajectory parameters calculated for each of the linguistic units into a plurality of clusters on the basis of the linguistic context; and
a model training unit that obtains a trained spectral trajectory model indicating for each cluster a statistical distribution of the spectral trajectory parameters belonging to that cluster.

2. The speech model generating apparatus according to claim 1, wherein the parameterizer calculates the spectral trajectory parameter of a target unit, which is the linguistic unit to be processed, on the basis of the spectral coefficients of each of the frames included in the target unit and the spectral coefficients of each of the frames included in each of the linguistic units which are disposed immediately before and after the target unit.

3. The speech model generating apparatus according to claim 2, wherein the clustering unit clusters the spectral trajectory parameters of the target unit into the clusters on the basis of the linguistic context of the target unit and the linguistic units which are disposed immediately before and after the target unit.

4. The speech model generating apparatus according to claim 1, wherein the parameterizer performs a linear transform of vectors of spectrum coefficients included in the linguistic unit to obtain the spectral trajectory parameter.

5. A speech synthesis apparatus comprising:
a text analyzer that acquires text information, which is a speech synthesis target, and performs a text analysis of the text information to generate linguistic context indicating content of language in the text information;
a model selector that, on the basis of the linguistic context of a linguistic unit in the text information, selects a spectral trajectory model of a cluster to which the linguistic unit belongs, from a storage unit storing spectral trajectory models clustered into a plurality of clusters on the basis of the linguistic context of a plurality of the linguistic units, the spectral trajectory model indicating a statistical distribution of a plurality of spectral trajectory parameters of a plurality of speech signals on the text information, and each linguistic unit having a plurality of frames; and
a generator that generates the spectral trajectory parameters of the linguistic unit on the basis of the spectral trajectory model selected by the model selector and obtains spectral coefficients by an inverse transformation of the spectral trajectory parameters.

6. The speech synthesis apparatus according to claim 5, wherein the generator generates an objective function of the spectral trajectory model selected by the model selector and maximizes the objective function to generate the spectral trajectory parameters of each linguistic unit.

7. A speech model generating program product having a computer readable medium including programmed instructions, wherein the instructions, when executed by a computer, causes the computer to perform:
acquiring text information and performing a text analysis of the text information to generate linguistic context indicating content of language in the text information;
acquiring a speech signal corresponding to the text information and calculating a set of spectral coefficients that describe the spectrum shape of each frame of the speech signal;
acquiring boundary information that indicates a beginning and an end of linguistic units and chunking the speech signal into the linguistic units on the basis of the boundary information, each linguistic unit expanding over multiple frames of the speech signal;
calculating a set of spectral trajectory parameters for a trajectory of the spectral coefficients associated with the linguistic unit;
clustering a plurality of the spectral trajectory parameters calculated for each of the linguistic units into a plurality of clusters on the basis of the linguistic context; and
obtaining a trained spectral trajectory model that indicates for each cluster a statistical distribution of the spectral trajectory parameters belonging to that cluster.

8. A speech synthesis program product having a computer readable medium including programmed instructions, wherein the instructions, when executed by a computer, causes the computer to perform:
acquiring text information, which is a speech synthesis target, and performing a text analysis of the text information to generate linguistic context that indicates content of language in the text information;
selecting, on the basis of the linguistic context of a linguistic unit in the text information, a spectral trajectory model of a cluster to which the linguistic unit belongs, from a storage unit that stores spectral trajectory models clustered into a plurality of clusters on the basis of the linguistic context of a plurality of linguistic units, the spectral trajectory model indicating a statistical distribution of a plurality of spectral trajectory parameters of a plurality of speech signals on the text information, and each linguistic unit having a plurality of frames; and
generating the spectral trajectory parameters of the linguistic unit on the basis of the selected spectral trajectory model and obtaining spectral coefficients by an inverse transformation of the spectral trajectory parameters.

9. A speech model generating method comprising:
acquiring text information and performing a text analysis of the text information to generate linguistic context indicating content of language in the text information;
acquiring a speech signal corresponding to the text information and calculating a set of spectral coefficients that describe a spectrum shape of each frame of the speech signal;
acquiring boundary information that indicates a beginning and an end of linguistic units and chunking the speech signal into the linguistic units on the basis of the boundary information, each linguistic unit expanding over multiple frames of the speech signal;
calculating a set of spectral trajectory parameters for a trajectory of the spectral coefficients associated with the linguistic unit;
clustering a plurality of the spectral trajectory parameters calculated for each of the linguistic units into a plurality of clusters on the basis of the linguistic context; and
obtaining a trained spectral trajectory model that indicates for each cluster a statistical distribution of the spectral trajectory parameters belonging to that cluster.

10. A speech synthesis method comprising:
acquiring text information, which is a speech synthesis target, and performing a text analysis of the text information to generate linguistic context that indicates content of language in the text information;
selecting, on the basis of the linguistic context of a linguistic unit in the text information, a spectral trajectory model of a cluster to which the linguistic unit belongs, from a storage unit that stores spectral trajectory models clustered into a plurality of clusters on the basis of the linguistic context of a plurality of the linguistic units, the spectral trajectory model indicating a statistical distribution of a plurality of spectral trajectory parameters of a plurality of speech signals on the text information, and each linguistic unit having a plurality of frames; and
generating the spectral trajectory parameters of the linguistic unit on the basis of the selected spectral trajectory models and obtaining spectral coefficients by an inverse transformation of the spectral trajectory parameters.
